(19) United States
(12) Patent Application Publication
(10) Pub. No.: US 2025/0006437 A1
(43) Pub. Date: Jan. 2, 2025

(54) DEVICE AND METHOD FOR MONITORING AN ON-LOAD TAP CHANGER

(71) Applicant: Maschinenfabrik Reinhausen GmbH, Regensburg (DE)

(72) Inventors: Karsten Viereck, Regensburg (DE); Anatoli Saveliev, Zeitlarn (DE); Michael Heger, Straubing (DE); Sebastian Daiser, Regenstauf (DE)

(21) Appl. No.: 18/688,420

(22) PCT Filed: Aug. 9, 2022
(86) PCT No.: PCT/EP2022/072319

§ 371 Date: Mar. 1, 2024

(30) Foreign Application Priority Data
Sep. 3, 2021 (DE) 10 2021 122 813.1

(51) Int. Cl. H01H 9/00; G01L 3/04

(52) U.S. Cl. CPC H01H 9/0027; G01L 3/04; H01H 2009/0061

(57) ABSTRACT

A device (1) for monitoring an on-load tap changer (2), comprising: —a motor drive (4); —a monitoring unit (11); and —a sensor (6) for acquiring an acoustic signal; wherein —the monitoring unit (11) determines a torque curve in the on-load tap changer (2) on the basis of a torque curve on the motor drive (4) and the acoustic signal of the sensor (6).

### CROSS REFERENCE TO RELATED APPLICATIONS

This application is a U.S. National Phase application under 35 U.S.C. § 371 of International Application No. PCT/EP2022/072319, filed on Aug. 9, 2022, and claims benefit to German Patent Application No. DE 10 2021 122 813.1, filed on Sep. 3, 2021. The International Application was published in German on Mar. 9, 2023 as WO 2023/030837 A1 under PCT Article 21(2).

### FIELD

The present disclosure relates to a device for monitoring an on-load tap changer and to a method for monitoring an on-load tap changer.

### BACKGROUND

On-load tap-changers usually have a diverter switch and a selector. On-load tap changers are usually actuated by means of a motor-drive unit in conjunction with a spring energy store. When a switching operation is carried out, the motor-drive unit pre-stresses the springs of the spring energy store. In this case, either compression springs are compressed or tension springs are extended. From a defined mechanical point, the energy introduced into the springs is abruptly released and the on-load tap changer is actuated. The motor-drive unit is mounted on the side of the transformer tank. From this a drive shaft train leads to the on-load tap changer. Known methods are used to determine a torque at a first location when monitoring the on-load tap changer. This first location is in the housing of the motor-drive unit. For complete and accurate monitoring, the unknown torque at a second location in the on-load tap changer would be relevant instead. What makes matters worse, as the inventors have recognized, is that there is no constant mathematical relationship between a torque determined in the motor-drive unit and the real torque at the on-load tap changer. Rather, temperature influences, aging and signs of wear on the mechanics of the on-load tap changer, the bearing points of the drive shaft train and the drive gear and also other influences over the entire operating life of the on-load tap changer, which usually extends over many years, change the torques occurring there in relation to the calculated torques. There is therefore no stable, i.e. constant, transmission behavior with regard to the torque curves between the motor of the motor-drive unit and the on-load tap changer driven by it over the entire operating time.

### SUMMARY

In an embodiment, the present disclosure provides a device that monitors an on-load tap changer. The device has a motor-drive unit; a monitor; and a sensor configured to acquire an acoustic signal. The monitor is configured to determine a torque curve in the on-load tap changer on the basis of a torque curve on the motor-drive unit and the acoustic signal from the sensor.

### BRIEF DESCRIPTION OF THE DRAWINGS

Subject matter of the present disclosure will be described in even greater detail below based on the exemplary FIGURES. All features described and/or illustrated herein can be used alone or combined in different combinations. The features and advantages of various embodiments will become apparent by reading the following detailed description with reference to the attached drawings, which illustrate the following:

FIG. 1 shows a schematic view of the device according to the present disclosure for monitoring an on-load tap changer.

### DETAILED DESCRIPTION

Aspects of the present disclosure provide a device for monitoring an on-load tap changer that determines an exact torque curve in the on-load tap changer and is of simple and compact design.

Other aspects of the present disclosure provide a method for monitoring an on-load tap changer that reliably and precisely determines the torque curve in the on-load tap changer.

According to a first aspect, the present disclosure provides a device for monitoring an on-load tap changer, comprising:
a motor-drive unit;
a monitoring unit;
a sensor for acquiring an acoustic signal;

Wherein:
the monitoring unit determines a torque curve in the on-load tap changer on the basis of a torque curve on the motor-drive unit and the acoustic signal from the sensor.

The device can be used to determine the torque curve in the diverter switch on the basis of an acoustic signal and the torque curve on the motor. The acoustic signal is used to determine the instant at which the diverter switch action occurred in the on-load tap changer. Based on this information, the torque of the motor can be converted into the torque in the on-load tap changer particularly accurately. The use of a sensor to acquire an acoustic signal also allows old systems to be retrofitted with the new device. The detection of the torque on the motor-drive unit can be determined, for example, directly using a torque sensor or indirectly on the basis of measured data on the motor.

According to a second aspect, the present disclosure provides a method for monitoring an on-load tap changer, wherein:
an acoustic signal is used to determine a time range for which a diverter switch action takes place during a switching operation;
the time range is translated into a torque curve of a motor-drive unit;
an instant for the diverter switch action is determined in the time range of the torque curve;
the instant for the diverter switch action is used to set reference points in the torque curve of the motor-drive unit;
the torque curve of the motor-drive unit is converted into a torque curve of the on-load tap changer.

By recording an acoustic signal and comparing this signal with a reference signal, the diverter switch action can be detected particularly accurately. The time range for which the diverter switch action should occur is first determined in the acoustic signal. It is precisely this range that is then translated into the time-based torque curve of the motor-drive unit and analyzed. The exact point in time at which the diverter switch action, in particular the unlatching of the spring energy store, occurred is then determined in this time range. Starting from this point, the torque curve of the motor-drive unit is referenced and converted into the torque curve of the on-load tap changer. The determining of the time at which the diverter switch action occurs and the referencing and conversion based thereon make the process particularly accurate, safe and reliable.

The determination of the diverter switch action, in particular the time range in the acoustic signal, is initially carried out in such a way that:
an envelope is generated from the raw data of the acoustic signal measured during the switching operation;
the envelope of the acoustic signal is compared with a reference envelope;
the reference envelope represents the diverter switch action;
the time range in which the diverter switch action takes place is determined or narrowed down by comparing the envelope of the acoustic signal and the reference envelope.

The reference envelope is, for example, already stored in a memory of the monitoring unit, or is stored in the monitoring unit after training. The reference envelope may have been generated from multiple previously recorded and synchronized signals from multiple switching operations. The reference envelope could furthermore be formed as an average, as a median or as a weighted average with added weighting factors for the raw data of multiple previously recorded and synchronized signals.

The reference envelope may have the length of the envelope of the entire signal. Alternatively, the length of the reference envelope may correspond only to a defined range or predetermined section of the envelope. The envelope of the sensor and the reference envelope are preferably compared using a correlation method, for example convolution or cross-correlation methods. The reference envelope contains the information that describes the diverter switch action. This information is looked for in the envelope of the measured signal.

The torque curve of the motor-drive unit can be determined using a torque sensor or by calculation on the basis of motor-specific data and measured values of a motor. The length of the torque curve corresponds to the length of the envelope of the acoustic signal. The torque sensor is preferably arranged on the drive shaft of the motor and at least at the beginning of the drive shaft train.

During the diverter switch action or at the beginning of the diverter switch action, the spring energy store is usually unlatched.

After the torque curve has been narrowed down to the time range from the envelope of the acoustic signal, the time or the instant at which the diverter switch action occurred can be determined in the applicable time range. This involves determining the largest negative slope or the highest negative gradient in the narrowed-down time range of the torque curve. This instant represents the diverter switch action and more precisely the unlatching of the spring energy store.

Furthermore, the torque curve of the motor-drive unit is converted into a torque curve of the on-load tap changer by means of a linear function. This function is specified and also stored in the monitoring unit.

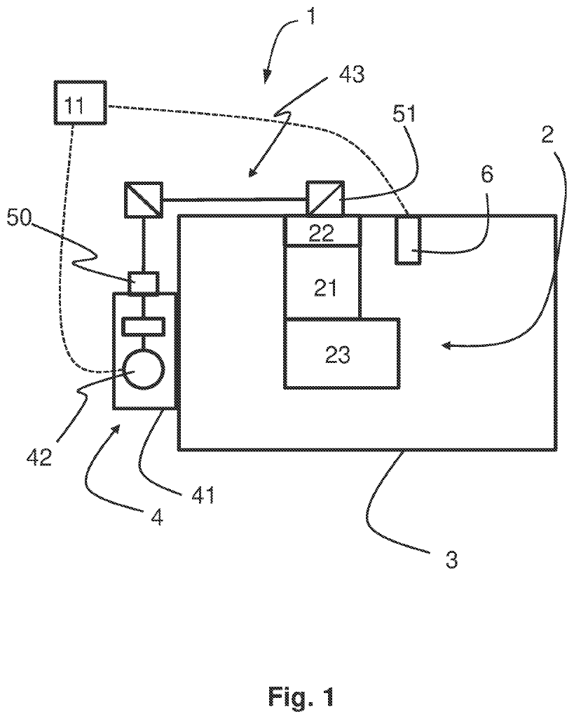

FIG. 1 shows a device 1 according to an aspect of the present disclosure for monitoring an on-load tap changer 2. The on-load tap changer 2 is installed in a transformer tank 3. The on-load tap changer 2 comprises a diverter switch 21 having a spring energy store 22 and a selector 23. A motor-drive unit 4 is arranged on the side of the transformer tank 3. The motor-drive unit 4 comprises a housing 41 containing a motor 42 that is connected to the on-load tap changer 2 via a drive shaft train 43. The drive shaft train 43 usually consists of multiple drive shafts and deflection clutches. To perform a switching operation, the motor 42 drives the on-load tap changer 2 via the drive shaft train 43. During the switching operation, the selector 23 is first actuated, a winding tap to be connected being preselected by a corresponding selector arm. At the same time, the spring energy store 22 is wound up. At a defined time/instant, the spring energy store 22 is unlatched and suddenly releases the energy previously stored during winding. This energy is used to actuate the diverter switch 21. Due to the non-ideal drive shaft train 43, the torque at position 50 on the motor 42 or on the motor-drive unit 4 does not correspond to the torque at position 51 on or in the on-load tap changer 2. In other words, the torque on the motor 4 due to the drive shaft train 43 is much higher than the torque on or in the on-load tap changer 2.

The device 1 according to an aspect of the present disclosure comprises means or is able to determine or detect the torque directly on the motor 42 during a switching operation, i.e. over time. A torque sensor arranged directly on the output shaft of the motor 42 or directly at the beginning of the drive shaft train 43 can be used for this. At the beginning of the drive shaft train 43 means that the torque sensor is arranged on a shaft that leaves or enters the housing 41 of the motor-drive unit 4. The sensor would transmit the measured torque curve to a monitoring unit (also referred to herein as a monitor) 11. It is irrelevant whether the sensor is arranged inside or outside the housing 41. The torque determination can also take place using the measured data of the motor 42 in conjunction with an applicable motor model. For this purpose, a current, a voltage and a phase angle of the motor 42 are measured or acquired by a central monitoring unit 11 during the switching operation. The data in a motor model are then converted into torque values in the monitoring unit 11 and a torque curve is thus generated. Other data that can be included in the calculation are the temperature of the motor 42 or the temperature near the motor 42. The monitoring unit 11 is designed in such a way that it could both measure a torque curve directly and calculate it indirectly from the data provided.

Furthermore, the device 1 comprises a sensor 6 for recording acoustic signals. This sensor 6 is preferably arranged near the on-load tap changer 2, preferably near the diverter switch 21, in particular near the spring energy store 22, preferably on the housing of the transformer 3 or on the cover or head of the on-load tap changer 2. The sensor 6 can be in the form of an acceleration sensor (e.g. a piezo sensor or an MEMS sensor). The central monitoring unit 11 is designed to evaluate and/or acquire the acoustic signals. It is connected to the motor-drive unit 4, in particular the motor or a torque sensor, and the sensor 6 by cable or wirelessly. Furthermore, the monitoring unit 11 is used to carry out the method according to the invention, or the device carries out the method. The monitoring unit 11 can acquire and evaluate the acquired raw data of the motor-drive unit 4 and the sensor 6. Alternatively, only the method according to an aspect of the present disclosure is carried out in the monitoring unit 11. Here, the motor-drive unit 4 and the sensor 6 are equipped with appropriate means that acquire and process the respective raw data of the signals. Alternatively, there may be provision for multiple acoustic sensors 6.

The device shown in FIG. 1 carries out the method according to an aspect of the present disclosure for monitoring an on-load tap changer 2. During a switching operation, i.e. during the actuation of the on-load tap changer 2, a torque curve of the motor-drive unit 4 is first determined. Switching operation of the on-load tap changer 2 means that the on-load tap changer 2 switches a load current from one winding tap of a step transformer to an adjacent winding tap. The torque curve is determined either using a torque sensor, by calculation on the basis of motor-specific data and measured values, or in some other way. At the same time, an acoustic signal is acquired using the sensor 6 during the switching operation. Alternatively, multiple signals from multiple sensors 6 can be used, the signals then being combined into one signal. This takes place in the monitoring unit 11 or in a separate unit as part of a pre-processing procedure.

In a next step, the raw data from the signal from the sensor 6 are converted into an envelope. The envelope represents the energy of the oscillations in a frequency range. In the next step, a time range in which the diverter switch action occurred is determined over this envelope. For this purpose, the envelope of the entire measured signal is compared with a reference envelope. In order to speed up the process, a previously determined range or predetermined section of the envelope, i.e. not the entire envelope, can be compared with a reference envelope in order to be able to narrow down the most likely time of the diverter switch action. The reference envelope is formed from multiple envelopes of individual signals. The reference envelope is generated from the raw data of multiple previously recorded and synchronized diverter switching signals. The reference envelope could be formed as an average, as a median or as a weighted average with added weighting factors for the raw data of multiple previously recorded and synchronized signals. The reference envelope contains the information that characterizes a diverter switch action.

The length of the reference envelope corresponds either to the entire length of the envelope of the recorded signal or to the length of the defined range or predetermined section.

The envelope of the sensor 6 and the reference envelope are compared using a correlation method, for example convolution or cross-correlation methods. Other methods for comparing the envelopes are possible. The reference envelope or defined range or predetermined section of the reference envelope represents the diverter switch action. Either the entire envelope can be compared with the reference signal, or only a previously defined range or predetermined section of the envelope in which the diverter switch action occurred. This range or section can be specified or, alternatively, determined through training.

After the comparison using correlation methods, a maximum match between the reference envelope and the envelope of the measured signal is determined. The time range in the envelope of the measured signal that most closely matches the reference envelope is marked as the diverter switch action.

After the time range in which the diverter switch action occurred has been determined in the envelope, this time range is translated into the time characteristic of the torque curve. In the now determined time range of the torque curve, a time/instant at which the spring energy store was unlatched, which is part of the diverter switch action, is determined.

This involves determining an instant having the largest negative slope or the highest negative gradient in the applicable time range of the torque curve. Reference points are then set in the entire torque curve on the basis of this instant. In other words, the torque curve is orientated to this point (instant). These reference points describe fixed events during the switching operation in the on-load tap changer 2. This reference point can be used to determine which part of the on-load tap changer 2 was actuated and when. Finally, the torque curve of the motor 42 is then converted into the torque curve of the on-load tap changer 2 by means of a linear function. The torque curve of the motor-drive unit 4 can also be converted into that of the on-load tap changer 2 in some other way.

The monitoring unit (sometimes referred to as a monitor) 11 can include a memory, a computing unit and a communication unit. The monitoring unit 11 is designed such that it can carry out the method according to an aspect of the present disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C

1: A device for monitoring an on-load tap changer, the device comprising:
a motor-drive unit;
a monitor; and
a sensor configured to acquire an acoustic signal,
wherein the monitor is configured to determine a torque curve in the on-load tap changer on the basis of a torque curve on the motor-drive unit and the acoustic signal from the sensor.

2: The device as claimed in claim 1, wherein the motor-drive unit comprises a torque sensor configured to determine torque.

3: The device as claimed in claim 1, wherein:
the monitor is configured to determine torque on the motor-drive unit on the basis of measured data on a motor of the motor-drive unit.

4: The device as claimed in claim 1, wherein:
the sensor is arranged near the on-load tap changer on a tap changer head or on a transformer housing.

5: A method for monitoring an on-load tap changer using the device as claimed in claim 1, the method comprising:
using an acoustic signal to determine a time range for which a diverter switch action takes place during a switching operation;
translating the time range into a torque curve of a motor-drive unit;
determining an instant for the diverter switch action in the time range of the torque curve;
using the instant for the diverter switch action to set reference points in the torque curve of the motor-drive unit; and
converting the torque curve of the motor-drive unit into a torque curve of the on-load tap changer.

6: The method for monitoring the on-load tap changer as claimed in claim 5, the method further comprising:
generating an envelope from the acoustic signal; and
comparing the envelope of the acoustic signal with a reference envelope, wherein:
the reference envelope represents the diverter switch action, and
the time range in which the diverter switch action takes place is determined by comparing the envelope of the acoustic signal and the reference envelope.

7: The method for monitoring the on-load tap changer as claimed in claim 5, wherein:
the torque curve of the motor-drive unit is determined using a torque sensor or by calculation on the basis of motor-specific data and measured values of a motor.

8: The method for monitoring the on-load tap changer as claimed in claim 5, wherein:
a spring energy store is unlatched during the diverter switch action.

9: The method for monitoring an on-load tap changer as claimed in claim 5, wherein:
the instant for the diverter switch action is determined, the instant being represented by a largest negative slope or a highest negative gradient in the time range of the torque curve.

10: The method for monitoring the on-load tap changer as claimed in claim 5, wherein:
the torque curve of the motor-drive unit is converted into a torque curve of the on-load tap changer by a linear function.

11: The method for monitoring the on-load tap changer as claimed in claim 5, wherein:
the reference envelope is generated from multiple previously recorded and synchronized signals from multiple switching operations.
